(19) United States
(12) Patent Application Publication
(10) Pub. No.: US 2006/0114883 A1
(43) Pub. Date: Jun. 1, 2006

(54) System and method for wireless cellular enabled information handling system router

(76) Inventors: Pratik M. Mehta, Austin, TX (US); Liam B. Quinn, Austin, TX (US)

Correspondence Address: HAMILTON & TERRILE, LLP, P.O. BOX 203518, AUSTIN, TX, 78720, US

(21) Appl. No.: 11/000,642

(22) Filed: Dec. 1, 2004

(51) Int. Cl. H04L 12/66

(52) U.S. Cl. 370/352

(57) ABSTRACT

An information handling system router integrates wireless local area networking components and wireless cellular wide area network components to route information between a wireless cellular wide area network and plural information handling systems interfaced with a wireless local area network supported by the wireless local area network components. The wireless cellular wide area network components may include a detachable wireless cellular transceiver to support wireless network interfaces when detached from the router, such as wireless cellular for voice telephone communication or a wireless card for single information handling system communication with the wireless cellular network. Alternatively, the wireless cellular wide area network components may integrate a transceiver that is authorized to communicate with the wireless cellular wide area network by a detachable authorization module, such as a SIM module of a wireless cellular.

### BACKGROUND OF THE INVENTION

1. Field of the Invention

The present invention relates in general to the field of information handling system networking, and more particularly to a system and method for cellular enabled information handling system router.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated in a reliable and secure way. The variations in information handling systems allow for information handling systems to be general or configured for a specific user or specific use such as financial transaction processing, airline reservations, enterprise data storage, global communications or peer-to-peer device sharing. In addition, information handling systems may include a variety of hardware and software components that may be configured to process, store, and communicate information and may include one or more computer systems, data storage systems, networking systems, and client and enterprise systems.

Information handling systems often interact with a number of peripherals to communicate, print or otherwise process information. Often, information handling systems interact with each other and with peripherals through networks, such as wireless local area networks (WLANs), by communicating through one or more routers. For instance, typical home networks communicate information between information handling systems and peripherals through wireless routers using the 802.11(a), 801.11(b) or 802.11(g) standards. The routers are generally associated with broadband modem devices, such as DSL or cable modems, that provide access to wide area networks (WANs), such as Internet service provider (ISP) networks for Internet access. WLANs have become a common choice for home networks because they reduce or eliminate the wiring of cables between information handling systems and peripheral devices and because they allow flexibility in movement of information handling systems and devices while communicating over the network. For instance, portable information handling systems often communicate over wireless networks using internal transceivers or add-on PCMCIA transceiver cards. These transceivers also support communication over multiple standardized network types such as wireless public “hot spots” that are deployed in locations where portable information handling systems are commonly used, such as airports and coffee shops. In these hotspots as well as in home, combined router and wireless access point devices are typically located at the entry point where a land-line network access is located, such as DSL or cable connection, in order to route information between wireless devices and the land-line network access.

WLAN's have a defined operating range in a typical home or business environment and most connect to a fixed broadband service such as a cable or DSL network. As an alternative, wireless telephone services, also commonly referred to as cellular services, are sometimes used to support wireless wide area network (WWAN) communication. Wireless cellular technology networks offer widespread network access for information handling systems and, with recent improvements that include packet-based communication, wireless cellular networks have achieved efficient broadband data rates. For example, 1xEV-DO provides wireless cellular data rates of 1.5 Mbps while 3 G technologies provide data rates of 3 Mbps with HSDPA scaling data rates up to 6 to 8 Mbps. Although wireless cellular based networking provides information handling system users with extensive coverage, service fees for access to wireless cellular networks are often substantial and coverage for wireless cellular based networks is often restricted or unreliable inside of buildings. Thus, an information handling system user who wants the flexibility and coverage of wireless cellular based networking also typically has land-line based networking, such as cable or DSL, at home and at work. However, multiple subscriptions increase user expenses and often lead to complexity in tracking usage and billing.

### SUMMARY OF THE INVENTION

Therefore a need has arisen for a system and method which provides efficient and effective wireless cellular wide area network access for information handling systems in a home or work premise networking environment.

In accordance with the present invention, a system and method are provided which substantially reduce the disadvantages, complexities and problems associated with previous methods and systems for information handling systems using wireless wide area network access. A wireless router integrates wireless local area networking components and wireless cellular wide area networking components to route information between a wide area network and information handling systems interfaced with the local area network.

More specifically, a wireless router supports communication between plural information handling systems and peripherals by routing information through a wireless local area network, such as 802.11(a), 802.11(b) or 802.11(g) wireless network, with wireless local area network components, such as transceiver, processor and memory. The wireless router also supports communication between the information handling systems and a wireless cellular wide area network by routing information communicated to the router through the wireless local area network to a wireless cellular wide area network with wireless cellular components, such as an integrated or selectively connected wireless cellular transceiver. An integrated wireless transceiver is authorized access to the wireless cellular network by connecting a wireless device to the wireless router, such as a wireless cellular, a wireless PDA or a wireless cellular information handling system card, and transferring authorization information from the wireless cellular device to the wireless router. Alternatively, an authorization module, such as a GSM SIM, detaches from a wireless handset or platform, such as a PDA or smart phone, to connect to the wireless router and authorizes access by the integrated transceiver. As yet another alternative, the wireless router connects with the wireless transceiver of an external wireless cellular device to communicate with the wireless cellular network. A user thus is enabled to communicate a variety of types of information over the wireless cellular network from information handling systems including data and voice information, and also may detach the wireless cellular device or authorization module for separate use from the wireless router for location independence. This architecture provides the fundamental platform to enable future usage applications, such as multimedia streaming over high speed cellular networks to the customer premises location as well as mobile locations.

The present invention provides a number of important technical advantages. One example of an important technical advantage is that information handling system users are provided with a unified approach to wireless wide and local area network access. For instance, using a single wireless cellular billing/profile account for voice and data, both in mobile and fixed locations, reduces overall user communication costs and simplifies network use, tracking and billing, such as through bundling of communication services. Selectively interfacing wireless cellular electronic keys with the fixed wireless router to “light up” a wireless local area network provides a secure physical authorization tied directly to a wireless cellular device and account, thus leveraging user authentication, user profiles, authorization and security measures already incorporated in wireless cellular networks. Wireless wide area network access through a wireless local area network router provides flexibility in the placement and usage of the wireless router within a home, a business or on the road to aid in achieving the best possible user experience.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a system of wireless local area and wide area networks interfaced through a common router; and

FIG. 2 depicts a functional block diagram of an information handling system router that integrates wireless local area and wireless wide area network communications.

### DETAILED DESCRIPTION

Information handling systems interface with a wireless cellular wide area network through a wireless local area network by routing information through a single router integrating both wireless local and wide area network components. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, application and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

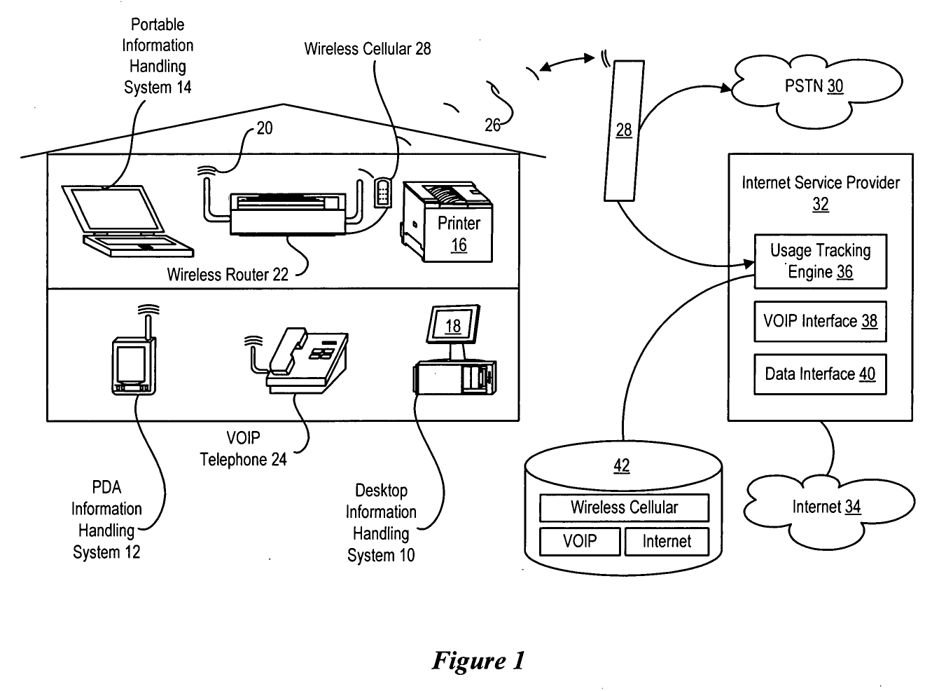

Referring now to FIG. 1, a system of wireless local area and wide area networks is depicted with the wireless wide and local area networks interfaced through a common router. Plural information handling systems are distributed in a premise, such as a home or business, including a desktop information handling system 10, a PDA information handling system 12 and a portable information handling system 14. The information handling systems interact with each other and with plural peripherals, including a printer 16 and display 18, through a wireless local area network 20 supported by a wireless router 22, such as a router compliant with the 802.11(a), 802.11(b) or 802.11(g) standards. In addition, one or more wireless VoIP telephones 24, such as wireless VoIP handsets, communicate voice information through the wireless local area network of router 22.

Wireless router 22 supports routing of information across wireless local area network 20 with conventional wireless local area network components, such as a transceiver, processor, and memory. Wireless router 22 also supports routing of information from wireless local area network 20 to a wireless wide area network 26, such as with a wireless network used by a wireless cellular interface system 28. Some examples of wireless cellular wide area networks 26 include GSM networks, CDMA networks, 1xEV-DO networks, UMTS, WCDMA, HSDPA networks and 1xRTT networks. A wireless cellular communications antenna wireless cell tower 28, such as a wireless cell tower, receives the wireless signals and forwards telephone communication to the PSTN 30 and data communications to an Internet service provider site 32 and the Internet 34. Wireless router 22 may be moved throughout the premise to optimize signal strength for wireless cellular wide area network 26 and wireless local area network 20 since the wireless communications frees wireless router 22 from a position near hardwired connections such as cable, DSL networks.

In operation, wireless router 22 activates to communicate information between information handling systems 10, 12 and 14 and wide area network 26 through local area network 20. In one embodiment, wireless router 22 activates by connecting with a wireless cellular wide area network device that provides a transceiver and authorization to access telephone wide area network 26. For instance, wireless cellular telephone 28 or a wireless cellular card connects to wireless router 22 to act as the transceiver and network access authorization. Alternatively, wireless router 22 has an integrated wireless cellular transceiver with authorization to access the wireless cellular network or with an authorization selectively enabled by connection of an authorization module, such as a SIM card. Unified tracking of wireless cellular wide area network use is managed by tracking the authorization associated with the network accesses with a usage tracking engine 36 and storing the tracking information in a tracking database 42. Information handling system functions, such as Voice over Internet Protocol (VoIP) and data communication, are managed by appropriate interfaces within Internet Service Provider site 32, such as a VoIP interface 38 and a data interface 40. Information handling systems 10, 12 and 14 communicate with Internet Service Provider interfaces through wireless local area network 20 and wireless cellular wide area network 28. For instance, a VoIP communication from an information handling system or a VoIP telephone 24 is established by routing VoIP packets to and from VoIP interface 38 through wireless router 22. Thus, when wireless cellular 28 or a similar wireless wide area network device provides the authorization for network access, wireless router 22 uses authorization from the existing wireless cellular device to scale across heterogeneous carrier network services to bind the usage model and billing to a single account.

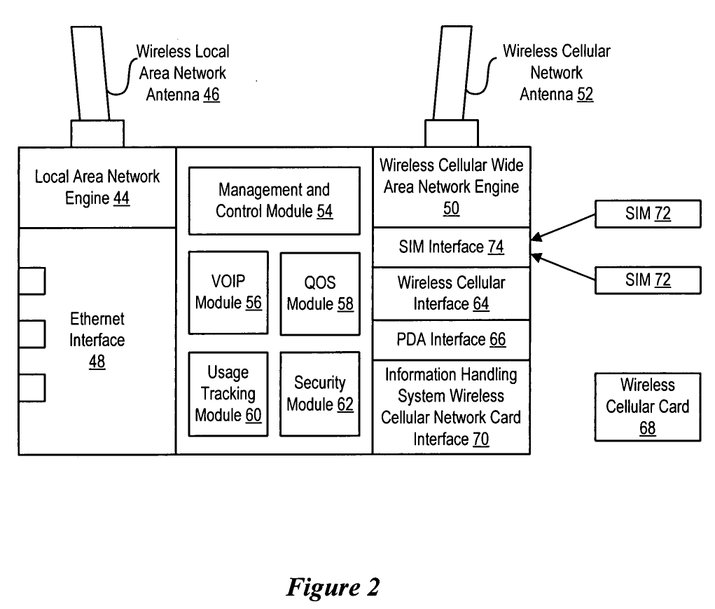

Referring now to FIG. 2, a functional block diagram depicts information handling system wireless router 22 that integrates wireless local area and wide area network communications. A local area network engine 44 communicates with information handling systems through a wireless local area network antenna 46 and ports of an Ethernet network interface card 48. A wireless cellular wide area network engine 50 communicates with a wireless cellular wide area network through a wireless cellular network antenna 52. Routing of information between the wireless local and wide area networks is managed by a management and control module 54 interfaced with local area network engine 44 and wireless cellular wide area network engine 50. Various hardware, firmware and software configurations may perform the functions set forth in FIG. 2, including a single processor or separate processors for each engine. Specific desired services are managed with associated modules, such as a VoIP module 56 that manages routing of VoIP packets and a QoS module 58 that manages packets by quality of service tags. A usage tracking module 60 coordinates usage tracking across the wireless cellular model, including tracking of wireless cellular use, wireless router accesses to the wireless cellular wide area network, and other wireless cellular devices, such as single information handling system card accesses. A security module 62 leverages native security of the wireless cellular wide area network and the wireless local area network to ensure secure communications and authorized use.

One convenient aspect of wireless router 22 is that a variety of communication services supported through the wireless wide area network may be bundled for convenient billing and usage tracking, including premise Internet access, premise PSTN access through VoIP communication, mobile wireless cellular voice access and mobile wireless cellular information handling system access. Access authorization and usage tracking are managed in one embodiment by selectively interfacing an authorized wireless cellular transceiver with wireless cellular wide area network engine 50. For instance, a wireless cellular interface 64 connects with a wireless cellular to support communication by wireless router 22 with a wireless cellular wide area network through the transceiver of the wireless cellular. Other types of wireless cellular devices may interface with wireless router 22 to support communication with a wireless cellular network using the transceiver of the wireless cellular device, including PDA devices that connect to a PDA interface 66 and information handling system wireless cellular cards 68 that connect to an information handling system wireless cellular network card interface 70. A wireless cellular card 68 may connect with a variety of form factors, such as PC Card, Express Card, MiniCard, SD, CF or other form factors that enable wireless cellular functions for the router.

In an alternative embodiment, wireless cellular wide area network engine 50 integrates a wireless cellular transceiver within wireless router 22 which is authorized to communicate over a wireless cellular network by connection of an external authorization module. For instance, a SIM 72 connects with a SIM interface to provide user credentials for authorization to access the wireless cellular network. As another example, a SIM profile is communicated from a connected wireless cellular device to authorize the integrated transceiver's communication with the wireless cellular network. Optionally, different users of a wireless local area network for a premise may thus selectively authorize wireless cellular wide area network access by insertion of a SIM profile associated with a user to provide varying degrees of service or access according to the identity of the user. When not using the wireless wide area network, the user removes the SIM or the wireless cellular device that provides authorization, making the wireless cellular device available for mobile use.

Although the present invention has been described in detail, it should be understood that various changes, substitutions and alterations can be made hereto without departing from the spirit and scope of the invention as defined by the appended claims.

What is claimed is:

1. An information handling system network comprising:
plural information handling systems, each information handling system having processing components to process information and wireless local area network components operable to communicate information over a wireless local area network; and
a router having wireless local area network components and wireless cellular wide area network components, the wireless local area network components operable to communicate information over the wireless local area network with the plural information handling systems, the wireless cellular wide area network components operable to communicate information over a wireless cellular wide area network, the router routing information between one or more of the information handling systems and the wireless cellular wide area network.

2. The information handling system network of claim 1 further comprising one or more information handling system peripherals having wireless local area network components operable to communicate with the plural information handling systems over the wireless local area network and the router.

3. The information handling system network of claim 1 wherein the router wireless cellular wide area network components comprise a detachable wireless cellular that enables the wireless cellular wide area network when coupled to the router and enables wireless cellular voice communication when detached from the router.

4. The information handling system network of claim 1 wherein the router wireless cellular wide area network components comprise a detachable information handling system wireless cellular wide area network card that enables the wireless cellular wide area network when coupled to the router and enables an information handling system to have wireless cellular wide area network communication when coupled to the information handling system.

5. The information handling system network of claim 1 wherein the router wireless cellular wide area network components comprise a detachable security module having authorization information that enables the wireless cellular wide area network components to communicate with the wireless cellular wide area network when the security module couples to the router and that enables a wireless cellular to communicate with the wireless cellular wide area network when the security module couples to the wireless cellular.

6. The information handling system network of claim 5 wherein the security module comprises a SIM.

7. The information handling system network of claim 1 further comprising a VoIP telephone having wireless local area network components operable to communicate voice information over the wireless local area network with the router, the router having a VoIP module interfaced with the wireless local area network and wireless cellular wide area network components, the VoIP module operable to support communication of voice information between the wireless local area network and the wireless cellular wide area network.

8. The information handling system network of claim 7 further comprising a quality of service module interfaced with the wireless local area network components and the wireless cellular wide area network components, the quality of service module operable to route information between the wide area and local area networks according to quality of service tags associated with the information.

9. A method of networking information handling systems, the method comprising:
communicating information between an information handling system and a router over a wireless local area network;
communicating information with the router over a wireless cellular wide area network; and
communicating at least some of the information between the wireless local area network and the wireless cellular wide area network with the router.

10. The method of claim 9 further comprising:
disconnecting a wireless cellular component from the router to disable the communicating of information over the wireless cellular wide area network; and
connecting the wireless cellular component to the router to enable the communicating of information over the wireless cellular wide area network.

11. The method of claim 10 wherein the wireless cellular component is a wireless cellular, the method further comprising communicating voice information over the wireless cellular when disconnected from the router.

12. The method of claim 10 wherein the wireless cellular component is a GSM compatible wireless cellular SIM, the method further comprising:
communicating user authorization information from the SIM to the router when the SIM connects with the router; and
using the authorization information to enable access by a wireless cellular transceiver integrated with the router to the wireless cellular network.

13. The method of claim 12 further comprising:
connecting plural SIMs to the router, each SIM having authorization information associated with one or more predetermined users; and
managing communication of information by the router according to the authorization information.

14. The method of claim 10 wherein the wireless cellular component is an information handling system wireless cellular wide area network card operable to interface an information handling system with the wireless cellular wide area network.

15. The method of claim 9 wherein communicating at least some of the information between the wireless local area network and the wireless cellular wide area network with the router further comprises communicating VoIP information.

16. The method of claim 9 further comprising locating the router within a premise to manage reception by the router of information communicated from the wireless cellular wide area network.

17. An information handling system router comprising:
a housing;
a wireless local area network engine disposed in the housing and operable to route information between plural information handling systems over a wireless local area network;
a wireless cellular wide area network engine disposed in the housing and operable to communicate information between a wireless cellular wide area network and the wireless local area network engine; and
a control module interfaced with the wireless local area network engine and the wireless cellular wide area network, the control module operable to route information between the information handling systems and the wireless cellular wide area network.

18. The information handling system router of claim 17 wherein the wireless cellular wide area network comprises a detachable wireless cellular transceiver, the wireless cellular transceiver interfacing with the wireless cellular wide area network engine to route information and detaching from the wireless cellular wide area network engine to perform voice communication.

19. The information handling system of claim 17 wherein the wireless cellular wide area network comprises a detachable wireless cellular transceiver, the wireless cellular transceiver interfacing with the wireless cellular wide area network engine to route information and detaching from the wireless cellular wide area network engine to perform information communication with a single information handling system.

20. The information handling system of claim 17 wherein the wireless cellular wide area network comprises an integrated wireless cellular transceiver and a detachable wireless cellular module, the wireless cellular transceiver routing information if the detachable wireless cellular module interfaces with the wireless cellular wide area network engine, the detachable module operable to enable voice communication of a wireless cellular if detached from the wireless cellular wide area network engine.
